(19) United States
(12) Patent Application Publication
(10) Pub. No.: US 2010/0070881 A1
(43) Pub. Date: Mar. 18, 2010

(54) PROJECT FACILITATION AND COLLABORATION APPLICATION

(75) Inventors: Karrie Hanson, Westfield, NJ (US); Gerald Michael Karam, Morristown, NJ (US)

Correspondence Address: AT&T Legal Department - JW;Attn: Patent Docketing, Room 2A-207, One AT&T Way, Bedminster, NJ, 07921, US

(73) Assignee: AT&T Intellectual Property I, L.P., Reno, NV (US)

(21) Appl. No.: 12/242,669

(22) Filed: Sep. 30, 2008

Related U.S. Application Data
(60) Provisional application No. 61/096,675, filed on Sep. 12, 2008.

(51) Int. Cl. G06F 3/048; G06Q 10/00

(52) U.S. Cl. 715/753; 705/7

(57) ABSTRACT

In one aspect, disclosed embodiments of a project facilitation and collaboration (PFC) service enable a user to access a PFC user interface. The PFC user interface enables the user to create a project and define and modify a membership for the project. The user interface also enables the user to perform, within the confines of the user interface, varied project activities including remotely or locally accessing asynchronous communication objects pertaining to the project, accessing documents and other media objects associated with the project, and initiating synchronous and asynchronous communications with members of the project.

### BACKGROUND

1. Field of the Disclosure

The present disclosure relates to the field of project management and, in particular, software applications and services for implementing project management.

2. Description of the Related Art

Project management applications tend to focus on the related concepts of time and money at the expense of addressing other key aspects of project behavior. Moreover, project management and most other software applications are highly developed for a narrowly tailored purpose and do not align well with typical project behavior, which may be characterized as an alternating sequence of communication tasks and activity or document tasks.

### BRIEF DESCRIPTION OF THE DRAWINGS

FIG. 1 is a block diagram of selected elements of a network for project collaboration;

FIG. 2 is a block diagram of selected elements of an embodiment of a client device in the network of FIG. 1;

FIG. 3 is a block diagram of selected elements of a server device in the network of FIG. 1;

FIG. 4 is a block diagram of selected data elements for use in FIG. 1;

FIG. 5 is a flow diagram of selected elements of an embodiment of a project facilitation and collaboration service;

FIG. 6 is a flow diagram of selected elements of an embodiment of a project facilitation and collaboration service;

FIG. 7 is a flow diagram of selected elements of an embodiment of a computer program product for project collaboration;

FIG. 8 is a depiction, in outline, of a main user interface for use in project facilitation and collaboration;

FIG. 9 is a depiction, in detail, of a user interface for use in project facilitation and collaboration;

FIG. 10 is a depiction, in outline, of a project facilitation and collaboration interface emphasizing the use of sticky notes;

FIG. 11 is a depiction, in detail, of a project facilitation and collaboration interface emphasizing the use of sticky notes;

FIG. 12 is a depiction, in outline, of a project facilitation and collaboration interface emphasizing an available resources screen;

FIG. 13 is a depiction, in detail, of a project facilitation and collaboration interface emphasizing an available resources screen;

FIG. 14 is a depiction of an embodiment of a “my projects” user interface;

FIG. 15 is a depiction of an user interface depicting a member's active and proposed project memberships;

FIG. 16 is a depiction of a user interface for use in project facilitation and collaboration emphasizing while-you-were-out functionality;

FIG. 17 is a depiction of an embodiment of a project collaboration user interface emphasizing the inclusion of live data feeds;

FIG. 18 is a depiction of an embodiment of an all projects user interface; and

FIG. 19 is a depiction of an embodiment of the all projects user interface of FIG. 18 emphasizing while-you-were-out functionality within the all projects user interface.

### DESCRIPTION OF THE EMBODIMENT(S)

In one aspect, disclosed embodiments of a project facilitation and collaboration (PFC) service enable a user to access a PFC user interface. The PFC user interface enables the user to create a project and define and modify a membership for the project. The user interface also enables the user to perform, within the confines of the user interface, varied project activities including accessing asynchronous communication objects pertaining to the project, accessing documents and other media objects associated with the project, and initiating synchronous and asynchronous communications with members of the project.

The PFC user interface may further enable the user to visualize, through a single user interface screen, at least portions of the project membership, the asynchronous communication objects, references to the media objects, and a communication suite suitable for initiating asynchronous and synchronous communication with one or more project members. In some embodiments, the PFC service filters the resources accessible to a service user to those resources associated with a project with which the user is associated, e.g., a project member is associated with a project and the PFC service filters the domain of all enterprise resources so that the user is visually presented with and has access only to project related resources.

In another aspect, disclosed embodiments of a service for supporting multi party collaboration on a project includes providing a persistent and hosted workspace that is remotely accessible to each of the project members using, for example, a conventional web browser and network connection. The workspace constitutes an integrated environment for initiating asynchronous and synchronous communication with project members, accessing documents and other types of media objects associated with the project, and while-you-were-out functionality for monitoring or identifying additions and other changes to resources associated with the project. In some embodiments, the PFC service may encompass the provision of a telephony portal through which a project member may access at least some of the PFC data and/or perform at least some PFC functions.

In some embodiments, the workspace supports functionality for defining a hierarchy of projects subordinate to the main project and for maintaining subordinate project resources for the subordinate projects. The subordinate project resources may be analogous to the main project resources, i.e., messages, announcements, membership lists, media object resources, and so forth may be maintained for each of the subordinate projects. A hierarchy of permission levels may be associated with a hierarchy of projects. For example, members may have permission to access only those projects and subprojects in which they are active members. Alternatively, members who have permissions for a particular project may inherit permission for all projects subordinate to that project. Conversely, permission to a subproject may imply permission to the project. In “open” embodiments, all project members may have access to all levels of subprojects. The various permission schema may be combined and other permission implementations may be included.

Embodiments of the disclosed PFC service may support sticky notes, a type of asynchronous communication exchanged among project members. In these embodiments, the integrated environment includes sticky notes creation and delivery resources. A sticky note may be implemented as a communication presented to a recipient when the recipient next accesses the project service generally or a particular project specifically. The sticky note may be presented to the recipient in a manner visually reminiscent of a note affixed to a bulletin board, with the sticky note being displayed overlaying underlying user interface elements. The sticky note may include a cosmetic appendage, e.g., an image of a pushpin, conveying the concept of the sticky note being “affixed” to the underlying workspace. The sticky note may include interactive elements enabling the recipient to respond in predefined ways, e.g., by generating a reply sticky note, initiating a click-to-dial phone call, and other appropriate ways.

In still another aspect, a disclosed computer program product, also referred to as a software product, includes computer executable instructions, stored on tangible computer readable media, for enabling project collaboration and facilitation. In some of the disclosed embodiments, the instructions include instructions for accessing and updating a database of project resources. The project resources database may include project membership data including contact information for members of the project, asynchronous communication objects pertaining to the project, and media object data indicative of media objects including text, audio, video, image, multimedia, and other types of documents associated with the project.

The computer program product as disclosed may further include instructions for generating a user interface including, a membership section identifying members of the project, a group communication section facilitating initiation of a communication with a plurality of the members, an asynchronous communication section displaying at least some of the asynchronous communication objects, and a media objects section displaying information indicative of at least some of the documents and other media objects associated with the project. The asynchronous communication section of a main screen of the project may include a discussion section for posting discussion messages and an announcement section for posting announcement messages.

In some embodiments, the membership section may include a member communication icon, e.g., a phone icon, an email icon, IM icon, etc., associated with a corresponding project member. The member communication icon facilitates rapid initiation of individual communication to the corresponding member. The membership section may include two or more member communication icons for a particular project member.

Some implementations of the group communication section include a synchronous communication icon to initiate a synchronous communication to at least one of the project members. The group communication section may include multiple synchronous communication icons including a huddle call icon and a conference call icon. The huddle call icon may initiate a huddle call communication in which a set of one or more members are dialed to create a conference call spontaneously without requiring the overhead frequently associated with traditional conference calls.

The group communication section may also include an asynchronous communication icon to initiate an asynchronous communication to one or more project members, e.g., an “email-all” icon for initiating an email to all project members.

In some embodiments, the instructions for accessing and updating the database include instructions for accessing and updating time stamp data indicating when media objects and other project resources were first imported into, created within, or otherwise associated with the project. The instructions may also include instructions for tracking time clock data indicating when project members' access a project, e.g., when project members and any other users log into and out of a project. In these embodiments, the software may support a while-you-were-out feature that provides an indication of any changes to the project resources since a user most recently logged into or otherwise accessed a project. The feature may be updated each time a user logs into a project so that the user is presented with a user interface section that contains information indicative of project activity that occurred during the interval the user was logged out of the project. From this section of the interface, a project member can form a very rapid estimation of the quantity of recent project activity.

The group communication icon may include a sticky note icon for generating and transmitting a sticky note, as referenced above. In these embodiments, the disclosed software product may include instructions for processing a sticky note, including instructions for posting the sticky note overlaying a home screen of a sticky note recipient. The software may include instructions for providing a set of options to a sticky note recipient, e.g., by accessing a drop down menu of the sticky note. The set of options may include an option to generate a return sticky note to an author of the sticky note, an option to reply to the sticky note author by email, and an option to reply to the sticky note author by initiating a click to dial phone call. The instructions for processing a sticky note may include instructions for posting the sticky note overlaying the home screen of a recipient until the recipient acknowledges the sticky note.

The software product may include support for generating a media object screen displaying the media object data. The media object screen may be invoked in response to a user clicking an element of the media objects section. The media object screen might be implemented as a pop up window or otherwise. The software product may enable project members to define media object groups, assign media object to the defined groups, and present the media objects organized by the defined groups. The project may selecting a media object group and the software product may selectively display the media object icons for media objects associated with the selected media object group. Some embodiments may permit project members to assign nicknames to media objects and may display any assigned nicknames when the media object screen is displayed. The media objects may include text documents, audio objects, image objects, video objects, and multimedia objects.

The software product may support the use of subordinate projects hierarchically arranged under a main project. In these embodiments, the project resources database may include subproject data indicative of a subproject. The home screen, in these embodiments, may include instructions for generating and displaying a subproject or “committee” section indicating one or more levels of any subordinate project hierarchy. For example, the subproject section may display an icon or the like for any subproject of which the member is associated.

The subordinate projects may support all of the features of the main project including, for example, the concept of a subordinate project membership, the use of asynchronous and synchronous communication resources, media objects, while you were out resources, and so forth. A subproject screen may be generated in response to a project member clicking an subproject icon in the subproject section. The subproject screen may include at least one of a set of elements including subproject membership section identifying members of the subproject, a subproject communication section facilitating initiation of group communication with a plurality of the subproject members, an asynchronous communication section displaying at least some subproject asynchronous communication objects, a media objects section displaying information indicative of at least some of subproject media objects; and a while your were out section indicative of resource changes to the subproject.

The user interface may include a project phone number section indicating a phone number dedicated or otherwise assigned to the project. The user interface may display a status of the project phone number and the project resource database may include phone call objects representing external communications received via the project phone number, e.g., voice mail messages left at the project phone number. The project phone number section may support telephony features, in addition to voice mail, including do-not-disturb and locate-me.

The software product may support various additional features including, as examples, support for associating a publicly accessible universal resource locator (URL) with the project, e.g., a Web site, and support for enabling project members to publish selected project resources to the URL. The software product may encompass a defined application programming interface (API) enabling third parties to develop applications extending the feature set. In this embodiment, the computer program product may include instructions for interfacing with an externally developed code module to expand a feature set of the program product. Examples of application that may be developed include, as examples, applications for navigation bars, to-do lists, membership voting, slide shows, Gantt charts, and so forth.

The software product may also support a data feed mode in which the user interface includes a data feed section displaying results of tests or programs associated with the projects. If, as an example, an ongoing maintenance project routinely receives test data or other types of data, the data may be formatted in a compatible format, e.g., html data, that the software product may include a data feed section in the user interface, replacing, in some cases, other sections of the interface.

The disclosed subject matter encompasses a communication-rich collaboration space that enables members of a project team to focus on a variety of heterogeneous project related activities within a single environment. Moreover, to the extent that project management and collaboration are viewed as a set of communication events and a related set of task events, the disclosed subject matter facilitates an integration between a communication event and the task event(s) to which the communication event pertains. The disclosed subject matter further encompasses a project “cradle” that provides a framework for storing project related objects of differing types and extends social network service concepts such as community building and information sharing to a project management and collaboration paradigm.

Disclosed project management and collaboration implementations provide an integrated framework that facilitates asynchronous communication, synchronous communication, and document sharing among the members of a dynamically adjustable project membership. By concentrating projected related communication and document activity within a single application, a project member can alternate between communication and other activities without invoking external and potentially distracting resources and applications such as email programs and web sites.

Illustrating the integral nature of the disclosed project collaboration concepts, a first project member might access a project document and, while reviewing the document, think of a question related to the document for a second project member. Within the confines of the disclosed application, the first project member can initiate an asynchronous or synchronous communication to the second project member, using point and click or equally user friendly techniques, ask the desired question and include a copy of or reference to the document embedded in the communication. The second project member may then receive the communication when the second member next accesses the project application and will have instant and easy access to the communication and the document to which it pertains.

In contrast to the application described in the preceding example, the software tools in a conventional workplace environment are generally narrowly tailored to achieve a specific application or task, e.g., word processing applications, email applications, and Web browsers. Each time a user has to perform a different type of activity and invoke the application for the specific activity, the potential for loss of focus exists. When a project member must access an email program to respond to a project related question, for example, the project member's attention may be diverted from the project by the presence of new, unrelated emails, old unrelated and unanswered emails, and so forth.

The disclosed project management applications support “real time” or synchronous telephony tools (e.g., phone call, conference call, huddle call) among project members, as well as “any time” or asynchronous communication tools (message boards, announcements, shared calendar, newsletters, emails, and sticky notes). Disclosed project management and collaboration implementations describe a highly available, persistent, hosted, common workspace that includes a project's documents and communications.

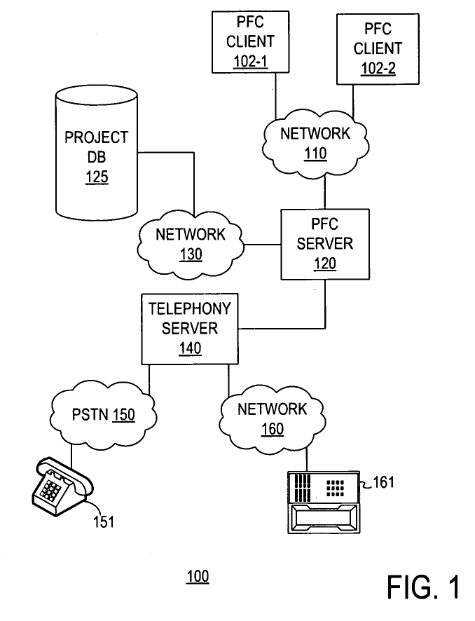

Turning now to the drawings, FIG. 1 depicts selected elements of a suitable architecture for implementing an embodiment of a project facilitation and collaboration (PFC) system 100. The implementation depicted in FIG. 1 emphasize the use of a network-hosted implementation in which client-side resources are primarily comprised of conventional software and hardware tools; thereby minimizing the amount of dedicated or application specific resources that are required at the end user location. In the depicted embodiment, for example, system 100 includes one or more PFC clients 102, including a first PFC client 102-1 and a second PFC client 102-2. PFC clients 102 are network aware clients configured and operable to communicate via a network 110. PFC client 102, in some embodiments, may be required only to include sufficient hardware and software functionality to achieve a network connection and invoke a network browsing application.

Network 110 may be a packet switched network such as an Internet protocol (IP) compliant network. Network 110 may be a private network such as local area network (LAN) or an enterprise's private intranet. In these embodiments, PFC clients 102 encompass any manner of device or resource capable of accessing a TCP/IP compliant network, such as the Internet, with a Web-based browser.

PFC system 100 as depicted in FIG. 1 further includes a project server 120 connected to network 110 and further connected to a project database 125 via a network 130. Network 130 and network 110 may share common elements and may be part of the same larger network. In other embodiments, network 130 may represent a private network that is insulated from network 110. In still other embodiments, project server 120 and project database 125 may be co-located within the same computing resource or facility.

The depicted embodiment of PFC system 100 further illustrates resources enabling external input to PFC system 100. PFC system 100 as shown includes, for example, a telephony server 140, which may be implemented as an IP PBX or other suitable type of device that supports communication between telephony devices including an analog telephone 151 communicating via the public switch telephone network (PSTN) 150, a voice over IP (VoIP) phone 161 communicating via the Internet, at least a portion of which is represented by network 160. In the depicted embodiment, telephony server 140 facilitates the processing and management of telephonic communications directed to PFC server 120. PFC server 120 may, for example, support, in conjunction with telephony server 140, a telephone number that is dedicated to a particular project and supports various telephony features including, as examples, “Locate Me”, Do Not Disturb (DND), and Voice mail features.

In the implementation depicted in FIG. 1, project members interact with the project application generally and specific project related data specifically, by invoking a Web browser, accessing PFC server 120, e.g., by entering a universal resource locator (URL) associated with PFC server 120, and authenticating with PFC server 120, e.g., by user ID/password, biometric sensing, and so forth. In this embodiment, PFC client 102 generates Web requests and PFC server 120 responds to those requests, by, for example, providing information sufficient for a web server executing as part of PFC client 102 to display a project management user interface to the user.

Although FIG. 1 depicts PFC system 100 in a traditional client-server implementation, other implementations and architectures are possible. An embodiment of PFC system 100 might include, for example, dedicated and application specific client software installed at each user location that operates directly on project database 125 or via a database server implementation of PFC server 120.

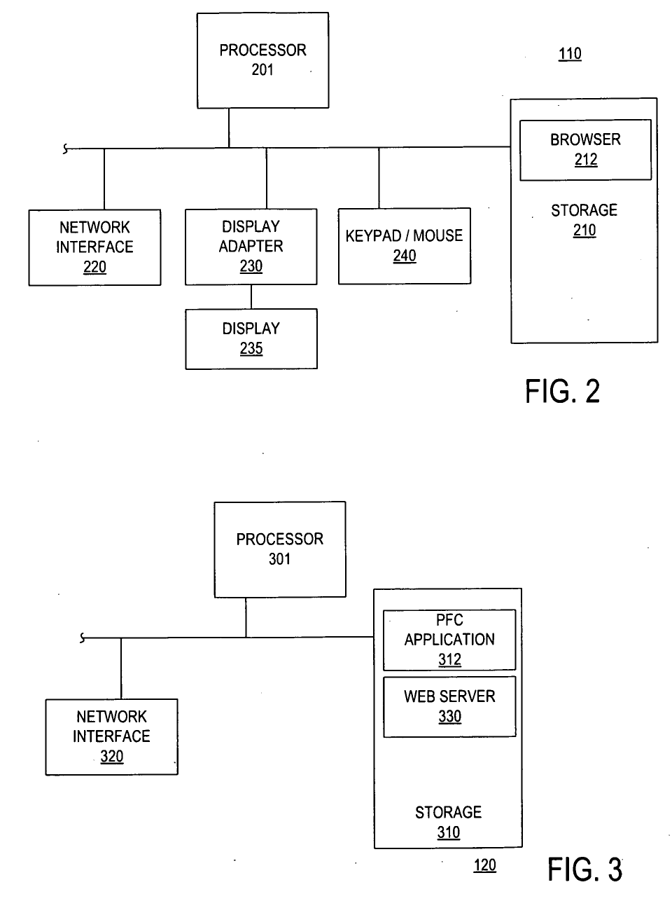

Turning now to FIG. 2, selected elements of an embodiment of PFC client 102 are depicted. As depicted in FIG. 2, PFC client 102 includes a processor 201 having access to storage media elements collectively referred to herein as storage media 210. In addition, PFC client 102 as shown includes a network interface 220, a display adapter 230 interfacing to a display 235, and a keypad/mouse interface 240. Network interface 220 may include a TCP/IP protocol stack suitable for supporting a network connection with an IP compliant network and server. Storage 210 as shown includes a instructions for a browser software application identified as browser 212. Browser 212 may be implemented with any of various freely available and pervasively distributed browsers. Turning to FIG. 3, selected depicted elements of an embodiment of PFC server 120 include a processor 301 having access to storage media 310, and a network interface 320. Storage media 310 as shown includes a software application identified as PFC application 312, which may provide all or portions of the project facilitation and collaboration functionality described herein. FIG. 3 also illustrates a Web server application 330 resident in PFC server 102, which enables PFC server 120 to perform basic Web server functions including responding to appropriately addressed HTML requests issued by Web browser 212.

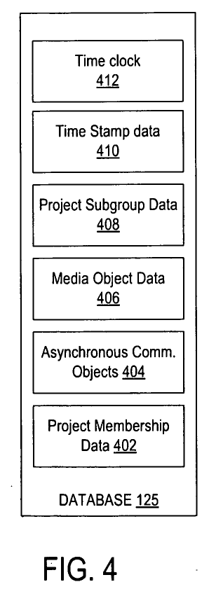

FIG. 4 illustrates exemplary selected data elements stored in Project database 125. The depicted data objects include project membership data 402, asynchronous communication objects 404, media object data 406, project subgroup data 408, time stamp data 410, and time clock data 412. Membership data 402 may include data indicative of identities and contact information of project members. Asynchronous communication objects 404 may include messages, announcements, or other asynchronous communication objects associated with a project or references or links to those objects. Media object data 406 may include various types of documents or files associated with a project or references to those documents or files. Project subgroup data 408 may include information pertaining to hierarchically arranged subprojects defined for a particular main project. Time stamp data 410, although depicted separately to emphasize while you were out functionality, may be included with the project resources or references to those project resources. Time stamp data 410 may include a time stamp indicating when a project resource was added to the project or modified. Time clock data 412 may include time stamp logs indicating login/logout information for the project members. Embodiments of PFC application 312 may employ the time stamp data 410 and time clock data 412 to enable while you were out functionality displaying or otherwise highlighting resource changes that have occurred while a project member was logged off.

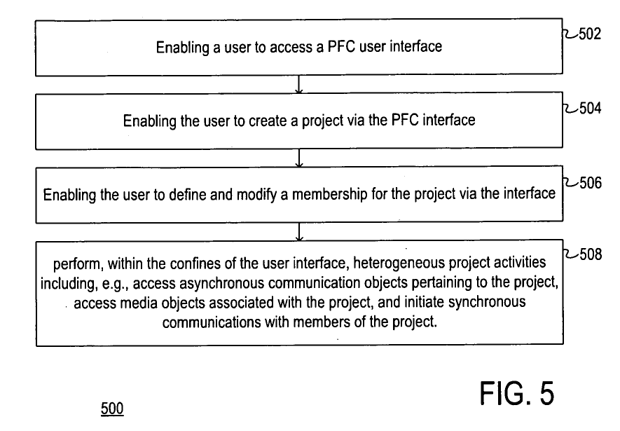

Some embodiments are implemented as a service or method for enabling end users to achieve project collaboration. The embodiments may be represented by flow diagrams emphasizing processes that may occur as part of the project facilitation and collaboration process. Referring to FIG. 5, for example, selected elements of an embodiment of a PFC service 500 are depicted. In the depicted embodiment, service 500 includes enabling (block 502) a user to access a user interface, e.g., enabling a project member to access PFC application 312 with a browser 212, where PFC application 312 provides the data for browser 212 to generate the user interface. The user interface enables the user to perform various project related functions, tasks, or activities including creating (block 504) a project, defining and modifying (block 506) a membership for the project, and performing (block 508), within the confines of the user interface, heterogeneous project activities. The project activities may include, as examples, accessing asynchronous communication objects pertaining to the project, accessing media objects associated with the project, and initiating synchronous communications with members of the project. By providing a single interface for performing these varied tasks service 500 beneficially reduces opportunities for diverting the attention of project members away from project related activities. For example, by enabling a user to initiate an asynchronous communication regarding a document or other type of media object without having to invoke a special purpose program to initiate the asynchronous communication, the user is not subjected to distractions that might otherwise occur when users notice new or unanswered emails in their in boxes.

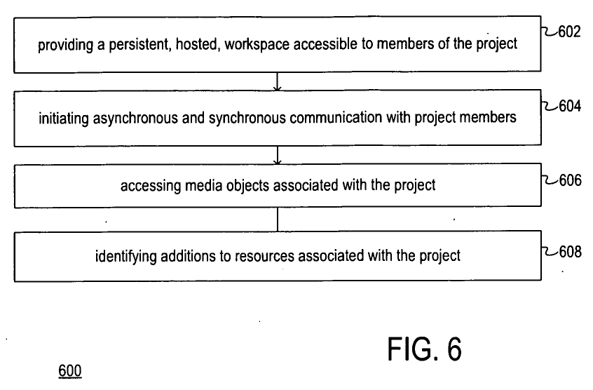

Referring to FIG. 6, a flow diagram depicts selected elements of an embodiment of a service 600 for supporting multi party collaboration. Service 600 as depicted in FIG. 6 includes providing (block 602) a persistent, hosted, workspace accessible to members of the project. The provided workspace comprises an integrated environment for initiating (block 604) asynchronous and synchronous communication with project members, accessing (block 606) media objects associated with the project, and identifying (block 608) additions to resources associated with the project.

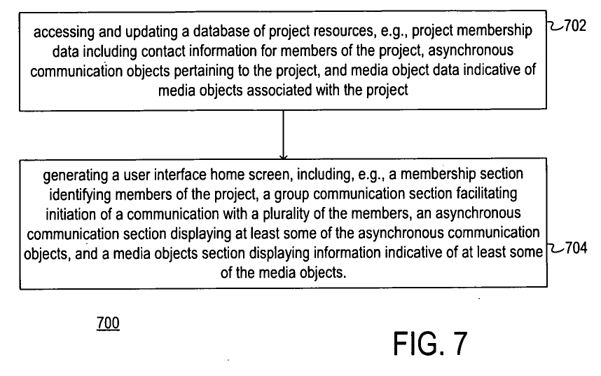

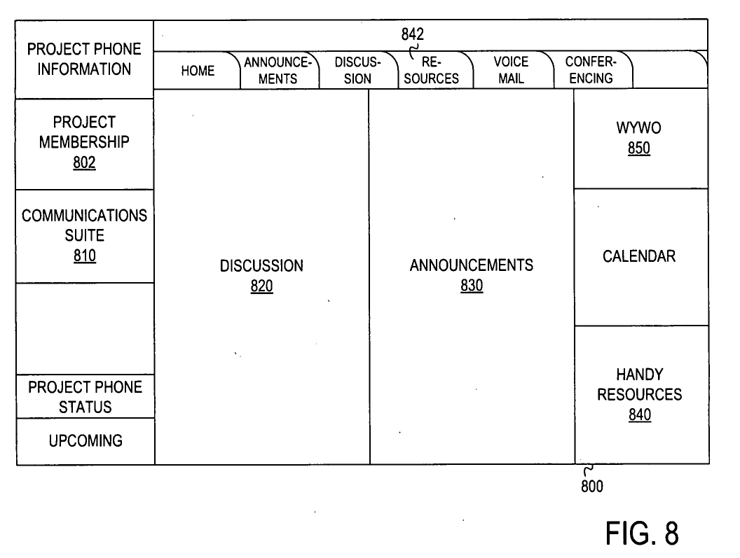

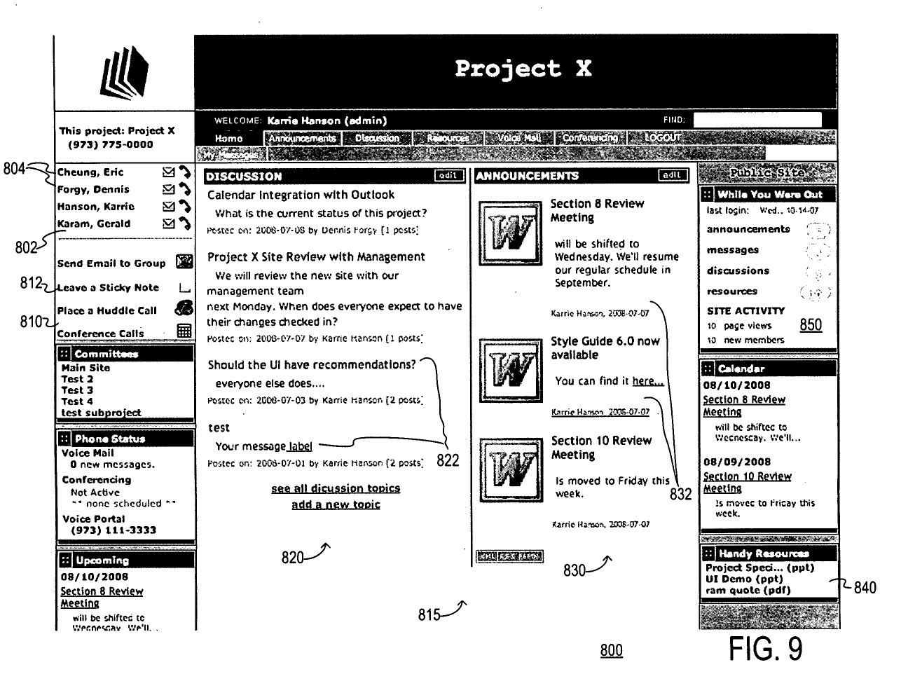

Referring to FIG. 7, a flow diagram depicts selected elements of a software product or computer program product 700. Computer program product 700 is implemented as computer executable instructions for managing information pertaining to a project. The instructions are stored on tangible computer readable storage media, e.g., storage media 310. In the depicted embodiment, the instructions includes instructions for accessing and updating (block 702) a database of project resources. The project resources in the database may include, e.g., project membership data including contact information for members of the project, asynchronous communication objects pertaining to the project, and media object data indicative of documents and other media objects associated with the project. Computer program product 700 as shown further includes instructions for generating (block 704) a project facilitation and collaboration user interface. An exemplary PFC user interface 800 is depicted in outline in FIG. 8 and detail in FIG. 9. The depicted embodiment of user interface 800 includes, for example, a membership section identifying members 804 of the project, a group communication suite 810 facilitating initiation of a communication with a plurality of the members, asynchronous communication sections 815 including discussion section 820 and announcements section 830. Asynchronous communications section 815 as shown displays at least some of the asynchronous communication objects including discussion postings 822 and announcements 832. User interface 800 as shown further includes a media objects section 840 displaying information indicative of at least some of the media objects.

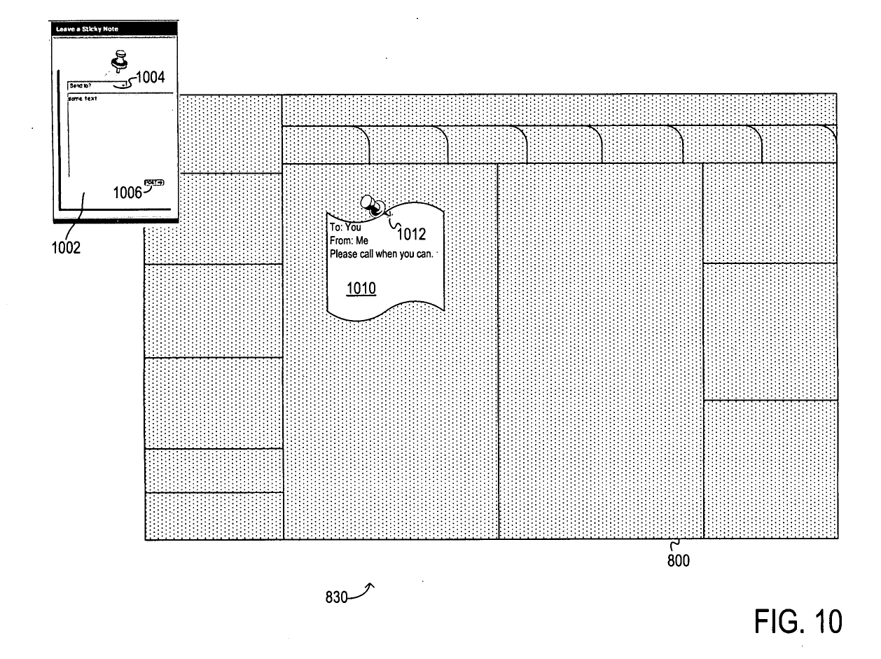

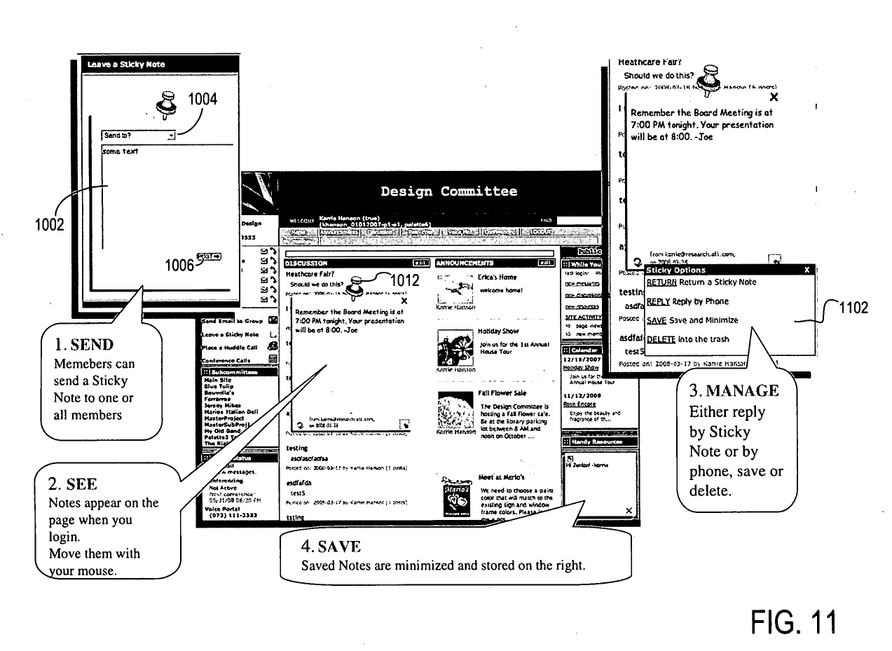

In some embodiments, group communication section 810 includes a sticky note icon 812 for initiating a sticky note to another project member. As depicted, in outline, in FIG. 10 and, in detail, in FIG. 11, asserting sticky note icon 812 may initiate a sticky note pop up 1002. The sticky note author types in the appropriate message or appends an image, audio, or other type of file to the sticky note 1002, selects a recipient from the drop down window 1004, which includes the identities for the project members, and delivers the sticky note by asserting a “post” element 1006.

FIG. 10 and FIG. 11 depict two possible implementations of the sticky note 1010 as it is delivered to and perceived by the recipient. The sticky note 1010 appears on the interface as a piece of paper that has been affixed to the interface using a pushpin 1012. Sticky note 1010 appears to overlay all of the elements of the interface so as to maximize its visibility to the recipient, who receives the sticky note when he or she next logs into the applicable project. FIG. 11 also depicts an embodiment of a sticky note implementation in which the recipient can respond to the sticky note using various actions listed in a response box 1102 that appears when the recipient “mouses” over the sticky note or asserts an appropriate control element of the sticky note. In the depicted embodiment of response box 1102, four response options depicted include responding by returning a sticky note to the author and a reply by phone option that may represent a “click to dial” feature in which the recipient clicks the reply by phone option, which causes the recipient's phone to ring. When the recipient picks up the phone the author or sender of the sticky note is dialed. Sticky notes can be saved and minimized as a resource as depicted in FIG. 11.

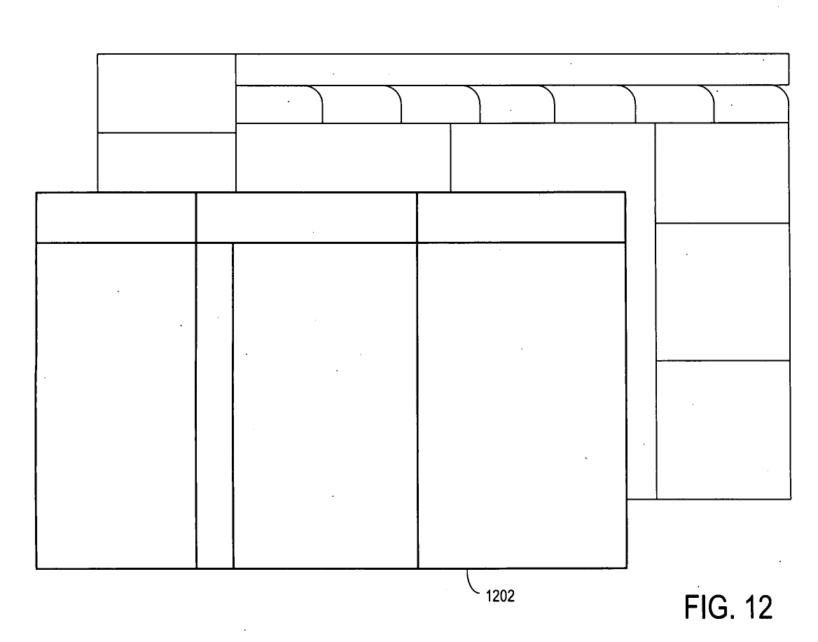

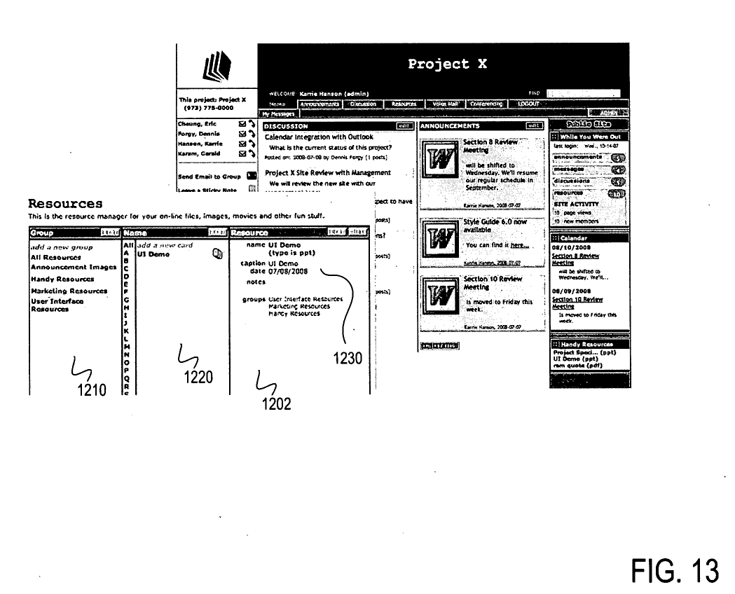

Turning now to FIG. 12 and FIG. 13, an outline and detail view of a media object window 1202 is depicted. In the depicted embodiment, media object window 1202 may be activated from the handy resources section 840 depicted in FIG. 8 or from a Resources tab 842 of interface 800. Media object window 1202 as shown lists a set of documents and other types of media objects. The depicted embodiment organizes the objects into groups 1210 and supports the use of nicknames 1220 for media objects 1230. The grouping and nickname support illustrated in media object window 1202 may beneficially help to organize media objects when there are a large number of such objects associated with a project.

Media objects 1230 as listed in window 1202 includes all media objects associated with a project. A subset of media objects 1230 may be exposed to the main user interface 800 in handy resources section 840. The subset of media objects depicted in handy resources section 840 may be selected by a project member, based on the most recently accessed media objects, or determined in some other way. Media objects window as shown in FIG. 12 and FIG. 13 is a pop up screen. Other embodiments may implement media window as a screen that does not pop up.

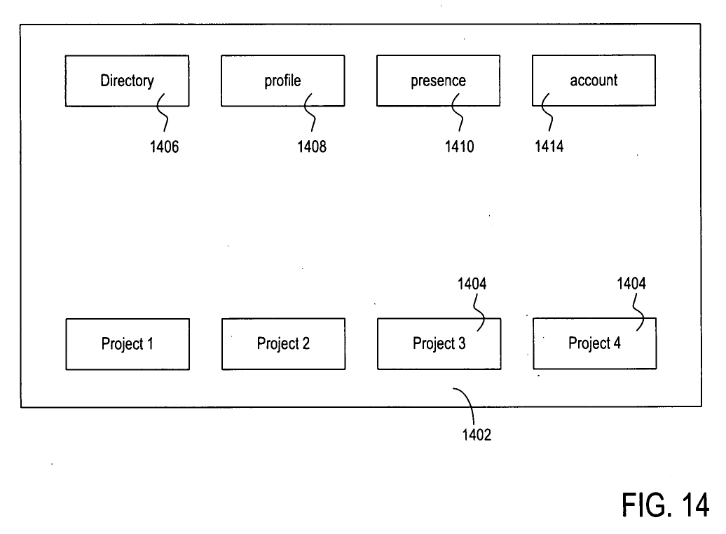

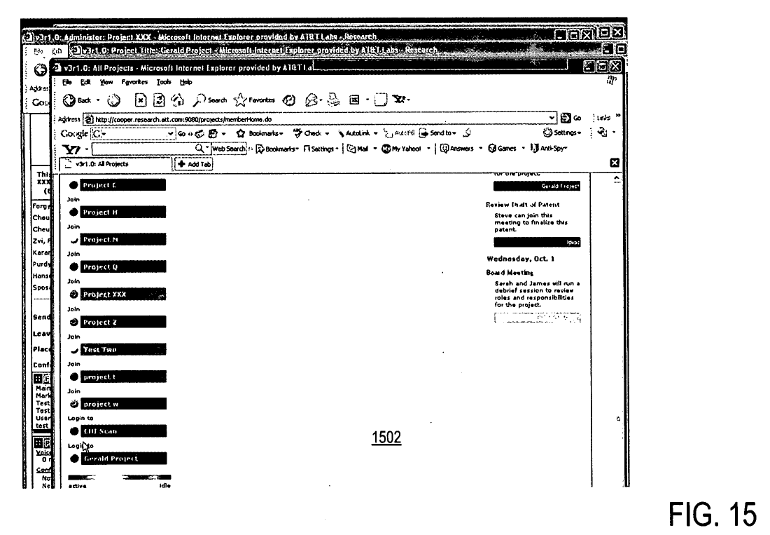

Turning now to FIG. 14, selected elements of a “my projects” page 1402 is depicted. My projects page 1402 includes links to all of the projects 1404 to which the user is a member as well as buttons for a number of other functions including a directory function control 1406, a profile function control 1408, a presence control 1410 to indicate the user's presence status, and an account function button 1412. The presence status indicated by presence control 1410 may be reflected in the membership section of the main page 800. A user may manipulate the presence information to indicate various types of presence status, e.g., “I'm in the office but cannot currently accept calls,” “I'm in the office and working on the applicable project,” and so forth. FIG. 15 depicts an alternative display 1502 of a member's projects. As depicted in FIG. 15, display 1502 identifies all projects to which the user is a subscribed and authenticated member as well as projects to which the user has been extended an invitation to join.

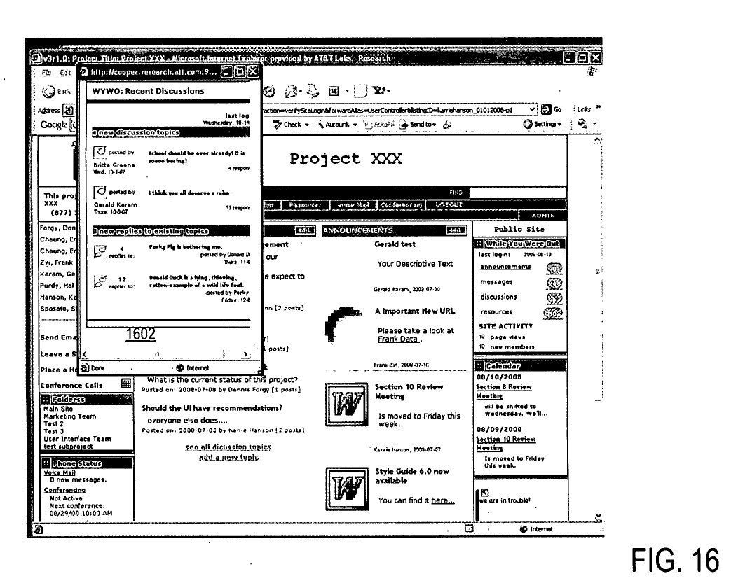

Turning now to FIG. 16, an implementation of while you were out (WYWO) functionality is depicted. A WYWO pop up screen 1602 provides a sample of WYWO information. The WYWO information informs the project member of activity and resources that have occurred since a last visit to the project by the member. WYWO pop up screen 1602 may reside in the main user interface screen 800 when minimized by the project member as shown by section 850 in FIG. 8 and FIG. 9. WYWO functionality beneficially provides project members with a visually perceptible indication of recent project activity and segregates “new” items from previously existing items to enhance the member's efficiency in reviewing and responding to new items.

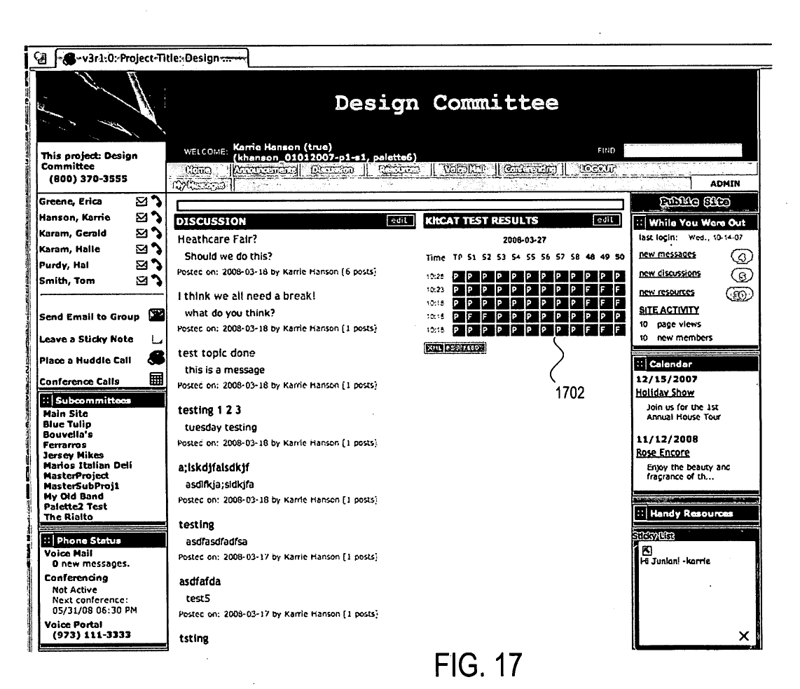

Turning now to FIG. 17, a data feed embodiment of user interface 800 is depicted. As depicted in FIG. 17, a portion of the announcements section from FIG. 8 has been replaced with a section 1702 of ongoing test results that are being performed by this particular project. Projects that accumulate real time data may wish to incorporate the data into the projects management framework. In some embodiments, the application or test generating the data may be formatted to produce test results in a compatible format. In other embodiments, the test data may need reformatting to an open standard format including, as an example, HTML.

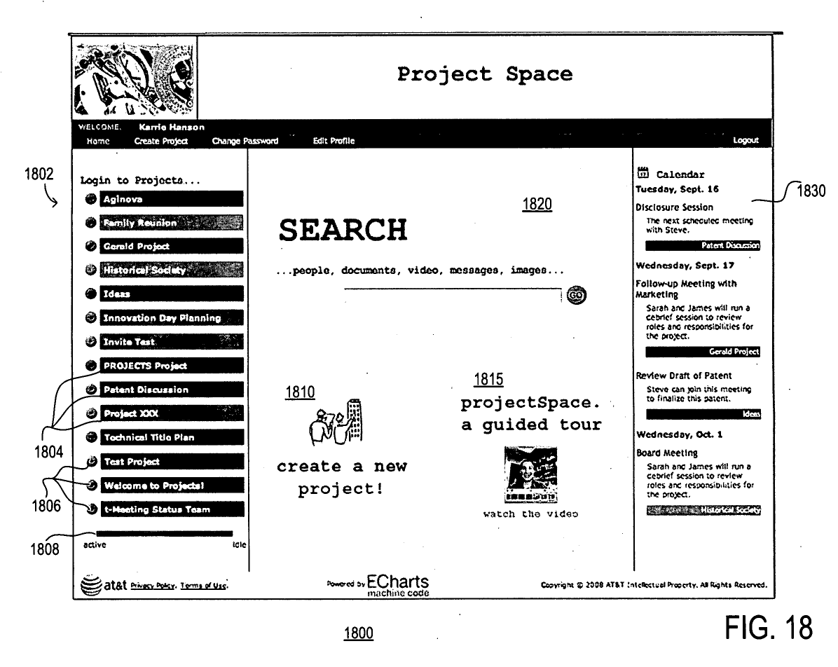

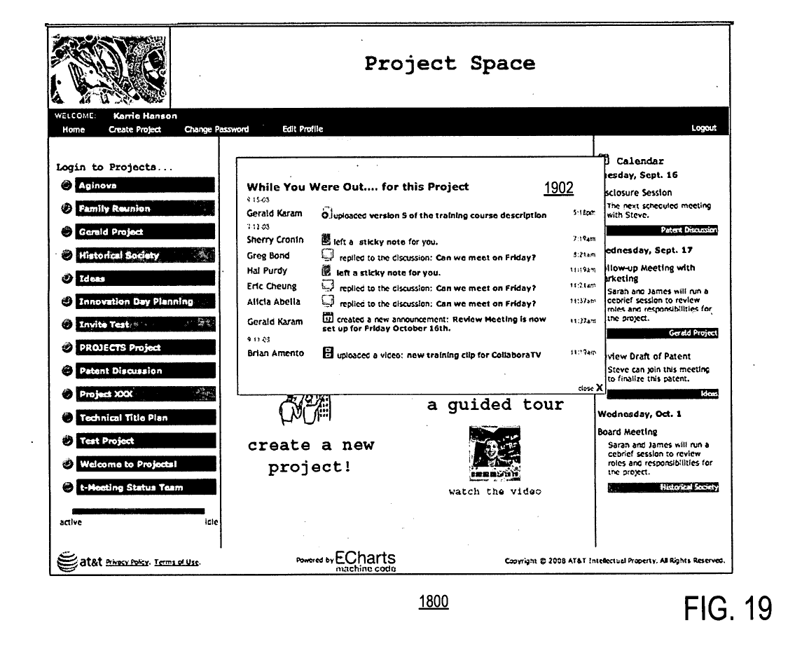

Referring now to FIG. 18 and FIG. 19, embodiments of an “All Projects” interface 1800. All Projects interface 1800 may represent a top-level page that a user encounters upon entering the PFC service. All Projects interface 1800 as shown includes a listing 1802 of the user's current projects with each project being indicated by a project bar 1804 and a project button 1806. The project bar displays the name of the project and provides the link to open the corresponding project. In some embodiments, the project button 1806 is color coded to indicate a level of activity for the corresponding project. An activity indication scale 1808 permits interpretation of the project button colors.

All Projects interface 1800 as shown further includes an element 1810 for creating a new project, a search facility 1820 for searching the PFC service database or a subset thereof, e.g., a search of the user's projects. A demonstration element 1815 may be included to provide new users with a tour of the PFC service and software. An integrated calendar 1830 conveys upcoming events for one, all, or some subset of the user's projects. FIG. 19 depicts a WYWO pop up screen 1902 positioned over All Projects interface 1800. WYWO pop up screen 1902 may appear, in some embodiments, when a user “mouses” over one of the project bars 1804, i.e., the WYWO pop up screen 1902 indicates WYWO items for the project that is moused over. All Projects interface 1800 may serve as an implementation of the my projects interface 1402 depicted in FIG. 14. All Projects interface may include, for example, links to the user's address book, links to a phone portal for the PFC service and so forth.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A computer program product, comprising computer executable instructions, stored on a computer readable medium, for managing information pertaining to a project, the instructions comprising instructions for:
accessing and updating a database of project resources, including:
project membership data including contact information for members of the project;
asynchronous communication objects pertaining to the project; and
media object data indicative of media objects associated with the project; and
generating a user interface home screen, including:
a membership section identifying members of the project;
a group communication section facilitating initiation of a communication with a plurality of the members;
an asynchronous communication section displaying at least some of the asynchronous communication objects; and
a media objects section displaying information indicative of at least some of the media objects.

2. The computer program product of claim 1, wherein the membership section further includes a member communication icon associated with a corresponding member, wherein the member communication icon facilitates individual communication to the corresponding member.

3. The computer program product of claim 2, wherein the membership section includes a plurality of member communication icons associated with a corresponding member and wherein at least one of the member communication icons is selected from the group consisting of an email icon to initiate an email message to the corresponding member and a telephone icon to initiate a telephonic communication to the corresponding member.

4. The computer program product of claim 1, wherein the group communication section includes a synchronous communication icon to initiate a synchronous communication to at least one of the project members.

5. The computer program product of claim 4, wherein the synchronous communication icon is selected from the group consisting of a huddle call icon and a conference call icon.

6. The computer program product of claim 1, wherein the group communication section includes an asynchronous communication icon to initiate an asynchronous communication to at least one of the project members.

7. The computer program product of claim 6, wherein the asynchronous communication icon is selected from the group consisting of a group email icon to initiate an email to a plurality of the project members, a sticky note icon to initiate a sticky note communication to one or more of the members, a huddle call icon to initiate a huddle call, and a conference call icon to initiate a conference call with one or more members.

8. The computer program product of claim 1,
wherein the instructions for accessing and updating the database includes instructions for accessing and updating:
time stamp data indicating when said media objects were first associated with the project; and
time clock data indicating when members access the project; and
wherein the instructions for generating the user interface home screen further include:
a while-you-were-out (WYWO) section indicative of changes to project resources since a user's most recent access of the project.

9. The computer program product of claim 1, wherein the group communication section includes a sticky note icon for generating and transmitting a sticky note and wherein the instructions further include instructions for processing a received sticky note communication including instructions for posting the sticky note overlaying a home screen of a sticky note recipient.

10. The computer program product of claim 9, further comprising instructions for providing a set of options to a sticky note recipient.

11. The computer program product of claim 10, wherein the set of options include an option selected from the group of options consisting of an option to generate a return sticky note to an author of the sticky note, an option to reply to the sticky note author by email, and an option to reply to the sticky note author by telephone.

12. The computer program product of claim 9, the instructions for processing a received sticky note include instructions for posting the sticky note overlaying the home screen of a recipient until the recipient acknowledges the sticky note.

13. The computer program product of claim 1, further comprising instructions for generating a media object screen displaying the media object data in response to a user clicking an element of the media objects section.

14. The computer program product of claim 13, further comprising instructions for assigning the media objects to media object groups.

15. The computer program product of claim 14, wherein the instructions for generating the media object screen include instructions for displaying information indicative of the media object group of a corresponding media object.

16. The computer program product of claim 15, wherein the instructions for generating the media object screen include instructions for selecting a media object group and selectively displaying media object icons for the media objects associated with the selected media object group.

17. The computer program product of claim 14, further comprising instructions for assigning nicknames to the media objects.

18. The computer program product of claim 17, wherein the instructions for generating the media object screen include instructions for displaying information indicative of nickname of a corresponding media object.

19. The computer program product of claim 13, wherein the media objects include objects selected from the list consisting of text documents, audio objects, image objects, video objects, and multimedia objects.

20. The computer program product of claim 1, wherein the project resources database further includes, project subgroup data indicative of a subproject and wherein instructions for generating the home screen include instructions for generating a subproject section indicative of the subproject when a user is a member of the subproject.

21. The computer program product of claim 20, further comprising instructions for generating a subproject screen in response to a user clicking an element of the subproject section.

22. The computer program product of claim 21, wherein the subproject screen includes at least one of a set of elements consisting of a subproject membership section identifying members of the subproject, a subproject communication section facilitating initiation of group communication with a plurality of the subproject members, an asynchronous communication section displaying at least some subproject asynchronous communication objects, a media objects section displaying information indicative of at least some of the subproject media objects, and a WYWO section indicative of project resource additions and modifications.

23. The computer program product of claim 1, wherein the asynchronous communication section includes at least one subsection selected from the group consisting of a discussion section for posting discussion messages and an announcement section for posting announcement messages.

24. The computer program product of claim 1, wherein the home screen includes a project phone number section indicative of at least one of a project phone number and a status of the project phone number and wherein the project resource database further includes project phone number objects indicative of external communications received via the project phone number.

25. The computer program product of claim 24, further comprising instructions for responding to an external phone call to the project phone number by taking an action selected from taking a voice mail message on behalf of the project phone number and altering the status of the project phone number.

26. The computer program product of claim 24, wherein the project phone number section includes support for telephony features including do-not-disturb and locate-me.

27. The computer program product of claim 1, wherein the instructions for generating a user interface include:
instructions for associating a publicly accessible universal resource locator (URL) with the project; and
instructions for selectively publishing project resources to the URL.

28. The computer program product of claim 1, further comprising instructions for interfacing with an externally developed code module to expand a feature set of the computer program product.

29. The computer program product of claim 1, wherein the instructions for generating the user interface further comprise instructions for a data feed section displaying results of tests or programs associated with the project.

30. A project facilitation and collaboration service enabling a user to access a user interface, the user interface enabling the user to:
create a project;
define and modify a membership for the project; and
perform, within the confines of the user interface, heterogeneous project activities including:
accessing asynchronous communication objects associated with the project;
accessing media objects associated with the project; and
initiating synchronous communications with members of the project.

31. The service of claim 30, the user interface further enabling the user to:
visualize, via a single user interface screen, at least portions of the project membership, the asynchronous communication objects, references to the media objects, and a communication suite suitable for initiating asynchronous and synchronous communication with a plurality of project members.

32. The service of claim 30, wherein the service filters resources accessible to a user associated with a project to those resources associated with the project.

33. A service for supporting multi party collaboration on a project, the service comprising:
providing a persistent, hosted, workspace accessible to members of the project, wherein the workspace comprises an integrated environment for:
initiating asynchronous and synchronous communication with project members;
accessing media objects associated with the project; and
identifying additions to resources associated with the project.

34. The service of claim 33, wherein the project represents a main project and the workspace is further suitable for:
defining and accessing a hierarchy of projects subordinate to the main project; and
maintaining subordinate project resources for the subordinate projects.

35. The service of claim 33, wherein the integrated environment for initiating asynchronous communication with project members includes an integrated environment for exchanging sticky notes with project members, wherein a sticky note comprises a communication presented to a recipient when the recipient next accesses the service, the sticky note being presented to the recipient in a manner visually reminiscent of a note affixed to a bulletin board, the sticky note being presented overlaying the underlying user interface elements.

36. The service of claim 35, wherein the integrated environment for exchanging sticky notes comprises an integrated environment for responding to a received sticky note by initiating, from a link presented by the received sticky note, at least one of: generating a reply sticky note and initiating a click to dial phone communication

37. The service of claim 33, wherein the service filters resources accessible to a project member to those resources associated with the project.
